(19) United States
(12) Patent Application Publication
(10) Pub. No.: US 2011/0227730 A1
(43) Pub. Date: Sep. 22, 2011

(54) SYSTEM AND APPARATUS FOR LOCATING AND SURVEILLANCE OF PERSONS AND/OR SURROUNDINGS

(76) Inventors: Brent Stevenson, Everett, WA (US); Kathy Stevenson, Everett, WA (US)

(21) Appl. No.: 13/014,049

(22) Filed: Jan. 26, 2011

Related U.S. Application Data
(60) Provisional application No. 61/316,300, filed on Mar. 22, 2010.

(51) Int. Cl. G08B 21/00

(52) U.S. Cl. 340/540

(57) ABSTRACT

An embodiment includes a method for receiving a safety device alert activation notification; determining a user profile associated with the safety device; and determining an alert level based on the safety device activation notification, where the determination may a first and second alert level. One embodiment includes determining that a first alert level is present; retrieving a contact list associated with the user profile; initiating contact with at least one contact on the contact list; and determining whether first level emergency criteria are met.

### PRIORITY CLAIM

This application claims the benefit of U.S. Provisional Application No. 61/316,300 filed on Mar. 22, 2010, which is incorporated herein by reference in its entirety for all purposes.

### SUMMARY

An embodiment includes a method for receiving a safety device alert activation notification; determining a user profile associated with the safety device; and determining an alert level based on the safety device activation notification, where the determination may a first or second alert level.

One embodiment includes determining that a first alert level is present; retrieving a contact list associated with the user profile; initiating contact with at least one contact on the contact list; and determining whether first level emergency criteria are met.

In one embodiment, a determination is made that first-level-emergency criteria are not met and an alarm-cancel message is sent. In another embodiment, a determination is made that first-level-emergency criteria are met, and the method further includes determining a first safety device location; selecting a first set of one or more alert targets based on the first safety device location; generating a message for at least one alert target in the first set; and sending the alert message to the at least one alert target in the first set.

In an embodiment, the method includes again determining that a first alert level is present; determining a second safety device location; determining, based on the first and second safety device location and the first set of one or more alert targets whether alert-target modification criteria are met; determining that alert-target modification criteria are met; selecting a second set of one or more alert targets based on the first safety device location; generating a message for at least one alert target in the second set; and sending the alert message to the at least one alert target in the second set.

One embodiment includes initiating a first user contact via the safety device; and determining whether a user-contact reply has been received; determining that a second alert level is present; determining whether the user-contact reply meets one of safe-reply criteria, hold-reply criteria, and emergency reply criteria; determining that the user-contact reply meets safe-reply criteria; and sending an alert-cancel message. One embodiment includes determining that the user-contact reply meets hold-reply criteria; and initiating a second first user contact via the safety device. One embodiment includes determining that the user-contact reply meets emergency-reply criteria; and sending a safety device emergency activation message to the safety device.

One embodiment includes determining that the user-contact reply meets emergency-reply criteria; determining a first safety device location; selecting a first set of one or more alert targets based on the first safety device location; generating a message for at least one alert target in the first set; and sending the alert message to the at least one alert target in the first set.

One embodiment includes again determining that a first alert level is present; determining a second safety device location; determining, based on the first and second safety device location and the first set of one or more alert targets whether alert-target modification criteria are met; determining that alert-target modification criteria are met; selecting a second set of one or more alert targets based on the first safety device location; generating a message for at least one alert target in the second set; and sending the alert message to the at least one alert target in the second set.

An embodiment includes a safety device having a wireless module, a positioning module, an imaging device, and audio input device, and audio output device, and input device, a memory, a processor, a power source, and a display. The safety device may be operable to capture audio, image and position data when activated by a user. Additionally, the safety device may be operable to identify one or more device proximate to the safety device. One embodiment includes a system that includes an the safety device, and alert display, a monitor center server, a law enforcement server, a first user device, and a second user device, which are operatively connected via a network.

### BRIEF DESCRIPTION OF THE DRAWINGS

The present disclosure is presented by way of at least one non-limiting exemplary embodiment, illustrated in the accompanying drawings in which like references denote similar elements, and in which:

FIG. 1 is a block diagram of a safety device in accordance with an embodiment.

FIG. 2 depicts a system of devices operatively coupled via a network, including the safety device of FIG. 1.

FIG. 3 is a block diagram of a safety-device-activation-response method in accordance with an embodiment.

FIG. 4 is a data flow diagram of data flow between the safety device and monitor center server of FIG. 2.

FIG. 5 is a block diagram of the emergency-protocol method of FIG. 3 in accordance with an embodiment.

FIG. 6 is a block diagram of the emergency-notification-protocol of FIG. 5 in accordance with an embodiment.

FIG. 7 is a data flow diagram of data flow between a plurality of devices in accordance with an embodiment.

FIG. 8 is a block diagram of the non-emergency protocol of FIG. 3 in accordance with an embodiment.

### DETAILED DESCRIPTION

When a person is abducted it may be desirable to immediately alert the public and law enforcement that the abduction has occurred. This is typically because the longer the person remains abducted, the more likely the person may be killed. This may be especially true within the first several hours from when the abduction occurs.

Unfortunately, unless there are direct witnesses to report the abduction, it may be several hours before law enforcement becomes aware of the abduction, and even longer for the public to become aware of the abduction. Additionally, once the abductor and abductee leave the scene of the abduction, it may be difficult to track and locate them.

Further yet, a person who may be in a dangerous situation, or a situation where an abduction may occur, may desire to be monitored in the event they do suffer harm. Unfortunately, it is difficult to provide individuals with such security, especially with little or no notice of such an event, or without monitoring equipment setup in a given area.

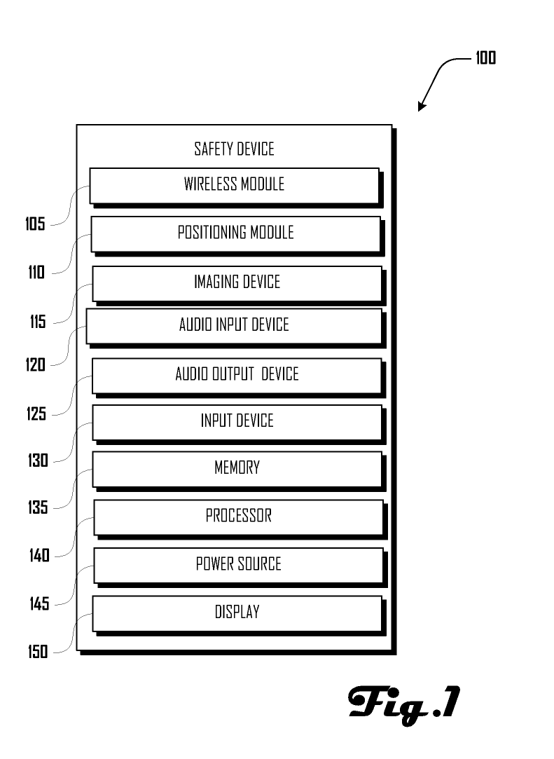

FIG. 1 is a block diagram of a safety device 100 in accordance with an embodiment. The safety device 100 may comprise a wireless module 105, a positioning module 110, an imaging device 115, and audio input device 120, and audio output device 125, an input device 130, a memory 135, a processor 140, a power source 145, and a display 150.

The wireless module 105 may comprise a suitable device (or group of devices) that is operable to send and receive wireless communications. The wireless module may be operable to send communications via various networks and various protocols. For example, the wireless device 105 may be operable to communicate via a cellular network, the internet, a satellite network, a radio network, or the like.

The positioning module 110 may comprise one or more devices operable to determine a position of the safety device 100. For example, position of the safety device 100 may be determined via a global positioning system (“GPS”), a compass, via proximity to one or more cellular network tower, via proximity to one or more wireless network transmitter, or the like.

The imaging device 115 may be operable to capture images in various regions of the electromagnetic spectrum, including infrared, ultraviolet, or within visible light. The imaging device 115 may be operable to capture pictures or videos in any suitable resolution including high-definition.

The audio input device 120 may be any suitable device operable to receive audio input and convert the input into digital or analog audio data or signals. For example, the audio input device 120 may be a microphone.

The audio output device 125 may be any suitable device operable to transmit audio signal of various frequencies. For example the audio output 125 may be a speaker.

The user input device 130 may be various types of input devices, which allow a user to provide input, and may include a keyboard, a touch screen, various buttons, or the like.

The memory 135, may be various types of digital memory, including volatile or non-volatile memory, or the like.

The processor 140 may be any suitable processor, processing system, controller, or module, and may be programmable to control one or more of the other components of the safety device 100. Furthermore, the processor 140 may perform image or audio processing on images or audio captured by the imaging device 115 or audio input device 120.

The power source 145 may be any suitable source of power such as a battery, and may provide power to one or more components of the safety device 100. The power source 145 may be recharged via a wired technique, or may be recharged wirelessly (e.g., via RF energy). In an embodiment, there may be a plurality of power sources 145.

The display 150 may be various devices which provide for visual display of an image, a video, light, or the like. The display 150 may be operable to present a complex image via a screen or touch-screen, or the display 150 may be operable to present simple presentations such as a single light via a light emitting diode or the like.

In an embodiment, the safety device 100 may be, or may comprise, a commercial device such as a smart-phone, a computer, a gaming device, a laptop computer, a GPS device or the like. However, in some embodiments, the safety device 100 may be any device operable to perform the operations described herein, and may be a part of other objects, including a stuffed animal, a toy, an article of clothing, or the like.

For example, in an embodiment, the safety device 100 may be a smart-phone, which may be operable to run an application, which allows a user associated with the smart phone to indicate various emergency or alert states or to activate data-capture and reporting via devices such as the positioning module, imaging device, audio input device, or the like. The user may provide such an indication via a touch screen, or the like.

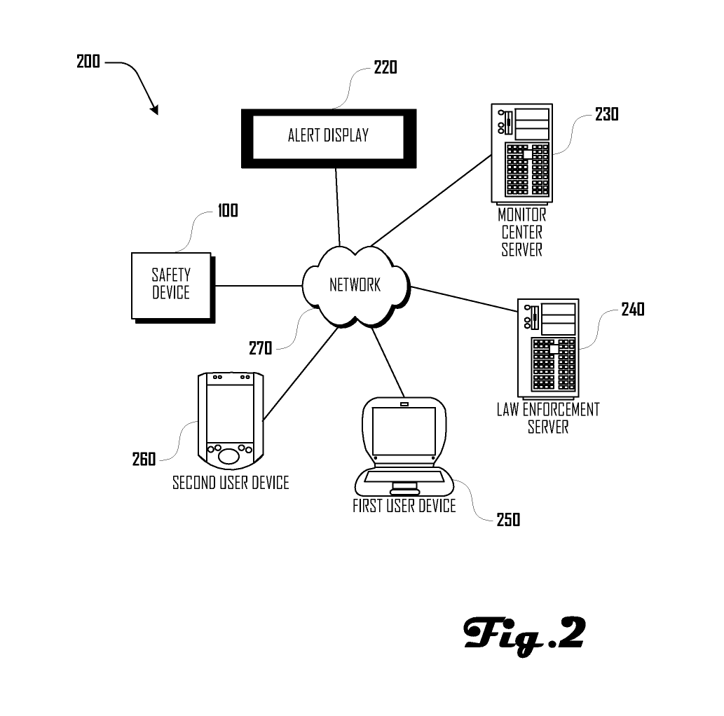

FIG. 2 depicts a system 200 of devices operatively coupled via a network 270, including the safety device of FIG. 1. The system 200 comprises an alert display 220, a monitor center server 230, a law enforcement server 240, a first user device 250, and a second user device 260. In an embodiment, there may be a plurality of any of the devices depicted in the system 200, or any of these devices may be absent.

The alert display 220 may be any suitable display that provides for presenting an alert, message, image, or the like. For example, in an embodiment, the alert display 220 may be a screen, which is positioned in a public place so that members of the public may see alerts and other messages regarding emergencies. As discussed further herein, an alert display 220 may display an alert relating to an abduction of a person associated with the safety device 100. In an embodiment, there may be a plurality of alert displays 220, or an alert display 220 may be absent.

The monitor center server 230 may be a server at that is operable to monitor the status of one or more safety devices 100 and send alert messages to various devices described herein. For example, as described in more detail herein, the monitor center server 230 may be operable to receive safety device activation notifications, initiate an emergency protocol, initiate a non-emergency protocol, initiate an emergency notification protocol, or the like.

The law enforcement server 240 may be associated with various law enforcement organizations, or the like. For example, the law enforcement server 240 may be associated with federal, state or local law enforcement. As described in more detail herein, a law enforcement agency associated with the law enforcement server 240 may receive alert notifications, or alert messages from the monitor center server 230, and may act upon such notifications or messages. A law enforcement agency may send out a notification to officers regarding an alert, send a notification to the public regarding an alert, or the like. Also, a law enforcement agency may present a notification regarding an alert or emergency on an alert display 220 or other display (e.g., an Amber Alert display system). In an embodiment there may be a plurality of law enforcement servers 240.

The first and second user device 250, 260 may be various types of suitable devices, which may be operable to receive alert notifications, alert messages, or the like. For example, the first and second user device 250, 260 may be a smart-phone, gaming device, desktop computer, laptop computer, pager, or the like.

In an embodiment, the user devices 250, 260 may be associated with various users. For example, where the person associated with the safety device 100 is a child, the user devices 250, 260 may be associated with a family member or guardian of the child, who may receive alerts regarding the child. The user devices 250, 260 may also be associated with other persons, who may or may not have a direct relation to a person associated with the safety device 100. For example, friends, members of the public, law enforcement officials, school personnel, a business owner, or the like may be associated with the user devices 250, 260. In an embodiment, as discussed further herein, the user devices 250, 260 may receive personalized alert notifications based on the identity of the person associated with the user devices 250, 260 and/or the location of the user devices. In one embodiment, there may be a plurality of user devices 250, 260.

The network 270 may comprise one or more suitable network operable to operatively couple a plurality of devices. For example, the network may comprise a cellular network, the internet, a satellite network, a radio network, or the like.

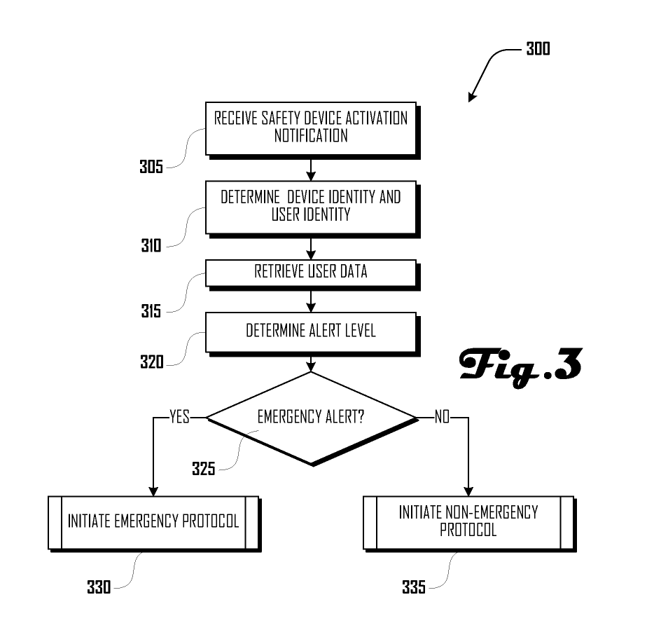

FIG. 3 is a block diagram of a safety-device-activation-response method 300 in accordance with an embodiment. The method 300 begins in block 305, where a safety-device-activation notification is received. For example, the safety-device-activation notification may be received from the safety device 100, which may have been activated by a person associated with the safety device due to an emergency, or due to a perceived dangerous situation.

In one embodiment, a safety-device-activation notification may be received from the monitor center server 230, a law enforcement server 240, the user devices 250, 260 or the like. For example, such a device 250, 260 or server 230, 240 may be operable to remotely activate the safety device 100 or may be operable to cause the monitor center server 230 to activate the safety device 100. In an embodiment, a safety-device-activation notification may be received even if the safety device 100 is not activated, but when an attempt to activate the safety device 100 is made. As discussed here, activation of the safety device 100 may include providing an indication regarding an emergency or non-emergency situation. In some embodiments, the safety device 100 may be powered and operational and activation only activates certain functions of the safety device 100. However, in some embodiments, activation may include powering the safety device 100.

Returning to the method 300, in block 310 a safety-device identity and user identity are determined, and user data is retrieved in block 315. For example, in an embodiment, there may be a user associated with a given safety device, such as a child, and a safety-device-activation notification may include an identification of such an associated user and/or the identity of the safety device 100. Such information may be used to retrieve user data, which may include data described herein, such as a contact list, home address, phone number, e-mail address, medical information, schedule, user appearance data (e.g., height, weight, age, hair color), user demographic data, or the like.

Returning to the method 300, in block 320 an alert level is determined, and in block 325 a determination is made whether the alert level is an emergency. If a determination is made that there is an emergency alert, then the method 300 continues to routine block 330 where an emergency protocol is initiated. However, if a determination is made that there is not an emergency alert, then the method 300 continues to routine block 335 where a non-emergency protocol is initiated.

Although FIG. 3 depicts a method wherein emergency and non-emergency alerts are determined, in one embodiment, there may be a plurality of alert types. Alerts may be related to a threat level, a danger level, or the like. For example, in one embodiment, there may be three alerts: “red”, “orange”, and “yellow”, wherein the “red” alert is indicative of high danger, “orange” is indicative of medium danger, and “yellow” is indicative of low danger.

Additionally, in an embodiment, there may be alerts associated with no danger or absence of danger. For example, there may be a “green” alert, which is indicative of no danger. As discussed in further detail herein, different alerts may cause or initiate different responses from the system 200 (FIG. 2), so as to provide an appropriate response to a threat or danger level.

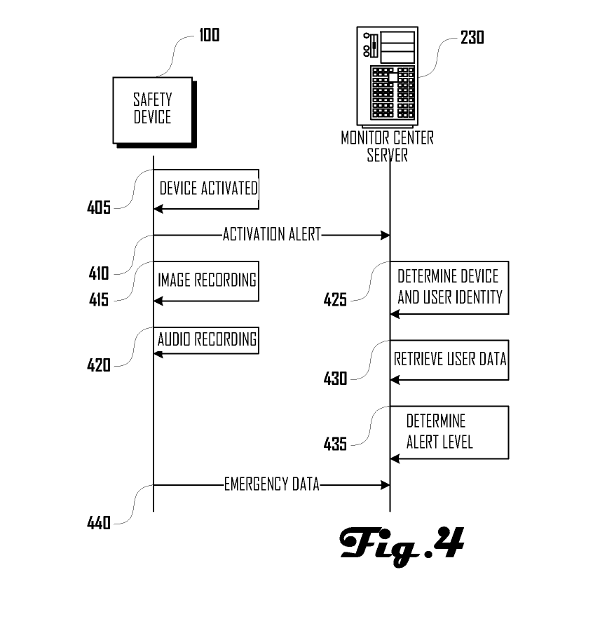

FIG. 4 is a data flow diagram of data flow between the safety device 100 and monitor center server 230 of FIG. 2 in accordance with an embodiment. The data flow begins where the safety device 100 is activated 405, and an activation alert is sent 410 to the monitor center server 230, where device and user identity is determined 425, user data is retrieved 430, and alert level is determined 435. Additionally, at the safety device 100, image recording 415 and audio recording 420 are initiated, and emergency data is sent 440 to the monitor center server 230.

For example, a safety device user may activate the safety device 100 in an emergency situation or where danger is perceived. The safety device 100 may then begin to record images and/or audio so that images and audio may be used to identify persons attempting to harm the user, witnesses, surroundings, or the like. Additionally, the safety device 100 may also record position data such as GPS coordinates, gyroscope data, accelerometer data, or the like, which may be used to determine the location of the safety device 100 or user, or may be used to determine whether the safety device 100 or user are moving.

In one embodiment, the safety device 100 may be operable to identify devices and/or networks that are near it. For example, the safety device 100 may be able to identify cellular telephones, smart phones, pagers, gaming devices, computers, wireless routers, or the like that are in proximity of the safety device 100. Such an identification may include position data, device user data (e.g., height, weight, age, hair color) device identify or the like.

Determination of devices near the safety device 100 may be used to determine position of the safety device 100, potential witnesses of a dangerous situation, potential perpetrators in a dangerous situation, or the like. In an embodiment, contact may be made with a device that is determined to be within proximity of the safety device 100. For example, a call may be made or notification sent to cell phones of persons within proximity of an activated safety device 100.

Data collected or obtained by the safety device 100 may be used in various ways. For example, it may be sent 440 to the monitor center 230, or may be sent to any other device in the system 200, or the like. Additionally, such data may also be stored on the safety device 100 in the memory 135. For example, the safety device 100 may store collected data, and may also send such data to the monitor center 230 so that it may be evaluated to determine if an emergency situation is present, so that it may be used as evidence in a criminal investigation, or the like.

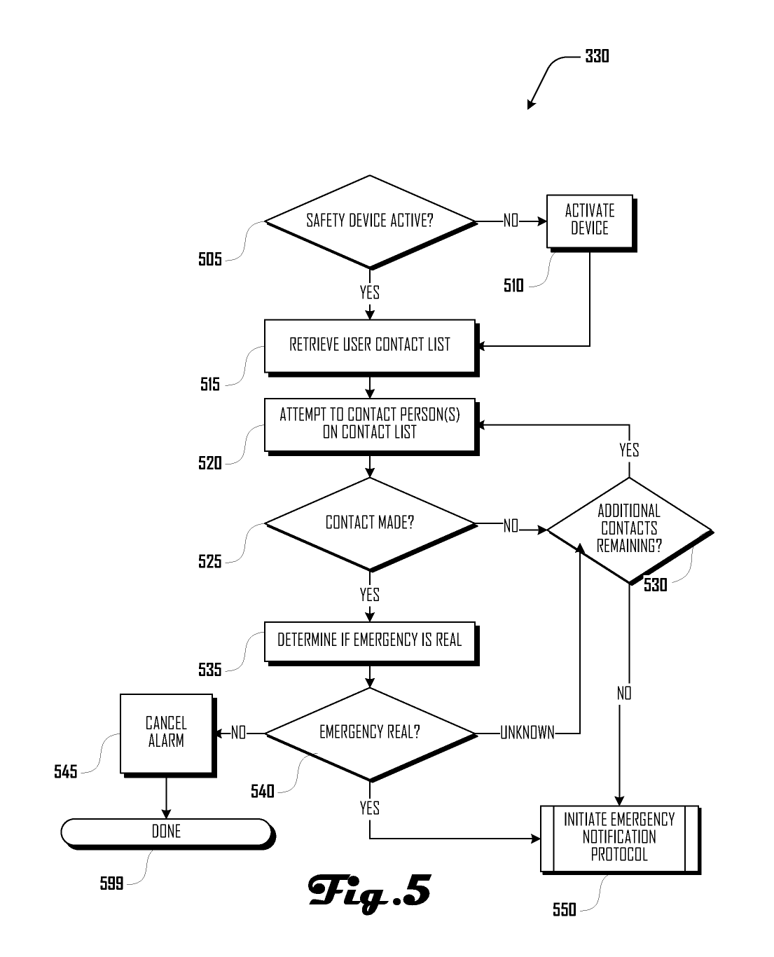

FIG. 5 is a block diagram of the emergency-protocol method 330 of FIG. 3 in accordance with an embodiment. The method begins in decision block 505, where a determination is made whether the safety device 100 is active (i.e., is it collecting data as discussed above). If the safety device 100 is not active, the safety device 100 is activated in block 510. For example, in an embodiment, user activation of the safety device 100 may initiate an emergency-protocol method 330; however, in one embodiment, an emergency-protocol method 330 may be initiated by another device in the system 200 (FIG. 2) and the safety device 100 may then be activated so as to collect data as discussed above. Such an activation may occur via a safety-device-activation message.

In an embodiment, an emergency protocol, (or non-emergency protocol, or the like) may be initiated based on the location of the safety device 100. For example, when the safety device 100 is detected within a defined area, or outside a defined area, an emergency or non-emergency protocol may be initiated. Additionally, an emergency or non-emergency protocol, or the like may be initiated based on time and position. For example, where the user associated with a safety device is a child, an emergency or non-emergency protocol may be initiated if the child (i.e., the safety device 100) is detected outside of a defined school-area during non-school hours.

Returning to the method 330, a user contact list is retrieved in block 515 and an attempt is made to contact one or more person on the contact list in block 520. For example, the user contact list may include various persons associated with the user of the safety device 100. For example, where the safety device user is a child, the user device may include parents, teachers, babysitters, or other guardians.

Additionally, in some embodiments, a contact list may be based on contacts and permissions of a social networking website or application. For example, persons who are listed as “followers” on a given Twitter account may comprise a contact list, and such contacts may be contacted via Twitter or via another means.

As described in further detail below, persons may be contacted to determine whether the safety device user is actually in an emergency situation, or so that such contact persons may check on the safety device user. Returning to the method in decision block 525 a determination is made whether contact is made with a person on the contact list. If contact is not made, then a determination is made whether additional contacts remain on the contact list in decision block 530. If additional contact remain, the method 330 cycles back to block 520, where an attempt is made to contact one or more person remaining on the contact list. However, if no additional contacts remain on the list, then the method continues to method block 550 where emergency-notification protocol is initiated.

However, if contact is made with a person in decision block 525, then a determination is made whether the emergency is real, and the method 330 continues to block 540, where it is determined whether the emergency is real, not real, or whether emergency status cannot be determined. Such a determination may be made based on emergency criteria, non-emergency criteria, or undetermined-status criteria, or the like. For example, if emergency criteria are met, a determination is made that the emergency is real.

If the emergency is determined to not be real, the emergency alarm is canceled in block 545, and the method 330 is done in block 599. An alarm may be cancelled via an emergency alarm cancel message, or the like. If the emergency is determined to be real, then emergency notification protocol is initiated in block 550. However, if a determination cannot be made as to whether the emergency is real or not, then the method 330 cycles back to decision block 530, where a determination is made whether additional contacts remain on the contact list.

For example, the monitor center server 230 may initiate contact with a person on the contact list by a telephone call, text message, e-mail, page, a social networking application, or the like. A telephone call may be made by a person, an interactive voice response (“IVR”) system, or the like, and if contact is made with the target person, then the target person may be asked to verify if the they are aware that the safety device user is in an emergency situation. The target contact person may provide various responses, which may include a verbal response, a response via a device, via a text message, or the like. In some embodiments, to cancel an alert or alarm, two or more contact persons may be required to confirm that an emergency situation is not present.

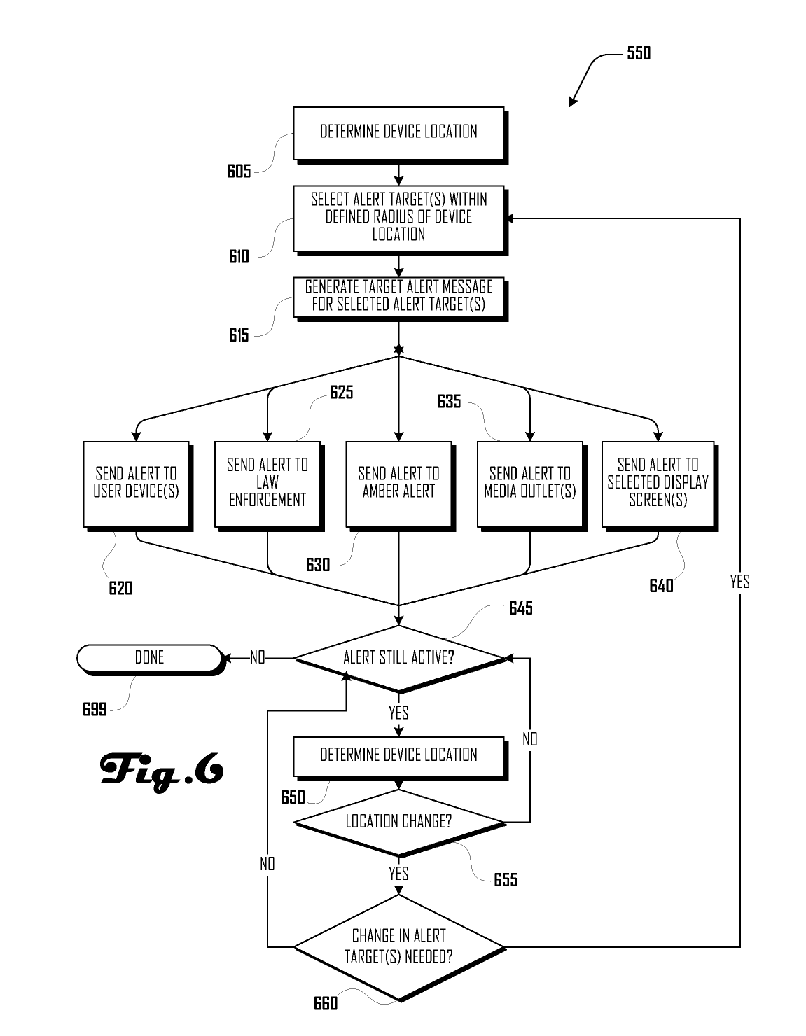

FIG. 6 is a block diagram of the emergency-notification-protocol 550 of FIG. 5 in accordance with an embodiment. The method 550 begins in block 605 where device location is determined, and in block 610 one or more alert target is determined within a defined radius of the device location. For example, it may be desirable to only provide emergency alert messages to persons or devices that are proximate to a safety device 100 because those people may be able to intervene or act as a witness to an emergency situation involving the user of the safety device 100, whereas persons not near the safety device 100 may not be able to provide such assistance.

Additionally, providing an alert message to devices or persons proximate to the emergency device 100 may be desirable so as to prevent persons viewing such alert messages from being inundated with alert messages such that they begin to ignore alert messages because few are relevant to them in terms of ability to intervene. Therefore, persons receiving or viewing an alert message may be more likely to act or intervene instead of ignoring the alert message.

For example, where a safety device 100 is determined to be located at a school, alert targets may include authorities or students at the school. Additionally, alert targets may also include businesses that are proximate to the school, law enforcement near the school, or the like.

In another example, where a determination is made that the safety device 100 is in motion and traveling on a highway, alert targets may include, signs along the highway, law enforcement traveling on the highway, businesses near the highway, persons in vehicles on the highway, or the like.

In one embodiment, different groups of alert targets may be selected based on other characteristics aside from proximity to the active safety device 100. For example, parents or other guardians, and certain law enforcement agencies may be contacted regardless of proximity to the safety device 100.

Additionally, alert targets may be selected based on characteristics such as alert target type. For example, all smart phones within one hundred (100) yards of the alert device 100 may be selected, whereas display screens within two hundred (200) yards of the display device may be selected. Selection of one or more alert targets may be based on any suitable criteria.

Returning to the method 550, a target alert message is generated for selected alert targets in block 615, and the generated alert may be sent to one or more user devices in block 620, to law enforcement in block 625, to an Amber Alert system in block 630, to one or more media outlets in block 635, and to one or more display screens in block 640. FIG. 6 only depicts examples of alert targets, and should not be construed to limit the types of alert targets to which an alert message may be sent. Additionally, alert messages may be sent to one or more alert targets at a given time. Sending alerts to alert targets is discussed further herein.

Returning to the method 550, in block 645, a determination is made whether the alert is still active. If the alert is not still active the method 550 is done in block 699. However, if the alert is still active, the safety device location is again determined in block 650, and a determination is made whether the safety device location has changed. If the safety device location has not changed, the method cycles back to decision block 645. However, if a determination is made that the safety device location has changed, then a determination is made whether the change in safety device location necessitates a change in alert targets. If no change in alert targets is necessitated, then the method 550 cycles back to decision block 645. However, if a change in alert targets is necessitated, the method 550 cycles back to block 610, where one or more alert target is selected. A determination that a change in alert targets is necessitated may be based on any suitable alert target modification criteria, or the like.

For example, where an active safety device 100 is determined to be traveling, alert targets may change based on location. Again referring to an example, where an active safety device 100 is determined to be traveling down a highway, a change in alert targets may be made because various alert targets may be closer or farther away from the safety device 100 at a given time. In one example, presume that the safety device 100 is traveling northbound on Interstate 5 (“15”) in Washington State. As the safety device 100 travels further north, it may be desirable to provide alerts on highway signs that are further north, and to extinguish alerts on highway signs that are increasingly south of the safety device. Similarly, persons or business may be selected or de-selected as alert targets, when a safety device comes within proximity of the person or business.

Also, where the safety device is traveling north toward Canada, the Royal Canadian Mounted Police, or border patrol law enforcement may be selected as an alert target in case the safety device 100 may cross the border. Also, where State or Country boundaries are crossed, different law enforcement may be alerted (e.g., crossing State lines may create Federal Jurisdiction for an emergency situation).

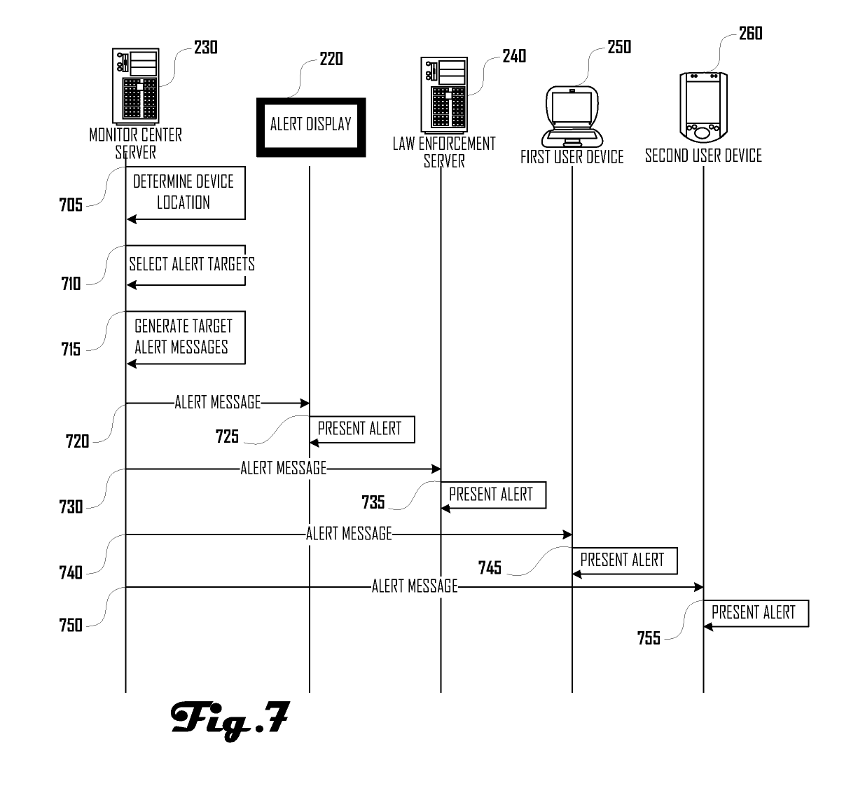

Target alert messages may also be generated for a specific device. For example, again assuming that a safety device 100 is traveling northbound on 15 in Washington State, highway signs may have different alerts based on their relative location to the safety device 100. Where a first highway sign is north of the northbound safety device, this first sign may receive and present a target message that reads “Abducted child in white Ford Taurus traveling North on 15, approaching this location from the south.” However, a second highway sign that is located south of the northbound safety device 100 may receive and present a target message that reads “Abducted child in white Ford Taurus traveling North on 15—recently passed this location.” Generation of alert messages is further discussed below in relation to FIG. 7.

FIG. 7 is a data flow diagram of data flow between a plurality of devices in accordance with an embodiment. The data flow begins where the monitor center 230 determines 705 a safety device location, selects 710 alert targets (i.e., the alert display 220, the law enforcement server 240, the first user device 250 and the second user device 260), and generates 715 target alert messages for the selected alert targets.

As discussed above, alert messages may be generated and formatted based on the alert target. For example, the alert display 220 may be a highway sign, and may only have the capacity to display a limited amount of information. Therefore, a short message that would be relevant and readable by persons traveling by the alert display 220 highway sign may be generated.

However, the law enforcement server 240 may receive a different alert message. For example, because law enforcement may desire additional information, the law enforcement server 240 may be sent data such as images, video or audio captured by a safety device 100, or the like. Additionally, it may be desirable to send updated alert messages with updated data substantially more frequently to the law enforcement server 240 than updated alert messages to the alert display 220 highway sign. This may be because frequent updates may not be relevant to viewers of the highway sign alert display 220, whereas frequent updates may be relevant to the law enforcement server 240.

Additionally, different alert messages may also be generated for the first user device 250 and second user device 260 based on the characteristics of these devices. For example, where the first user device 250 is a laptop computer, alerts may be sent to the first user device 250 via e-mail, whereas if the second user device 260 is a smartphone, an alert may be sent via text message, via an application on the smartphone or via a social networking application.

Because the user of a smartphone may be traveling, or more mobile than a person using a laptop computer, the first user device 250 may not receive alert updates as frequently as the second user device 260 does, and may receive different types of alerts, with different information. For example, the second user device 260 may display the location of the safety device 100 relative to the second user device 260, whereas the first user device may not display such information. In accordance with various embodiments and as discussed herein, any suitable alert message may be generated for a given target device based on any suitable or desired criteria.

Returning to FIG. 7, alert messages are sent 720, 730, 740, 750 to the alert display 220, the law enforcement server 240, the first user device 250 and the second user device 260, respectively. The alert messages are presented 725, 735, 745, 755 on the alert display 220, the law enforcement server 240, the first user device 250 and the second user device 260 respectively.

Alert messages may be presented on a device screen, via audio, or the like. For example, an alert message may include text or images that relate to an alert level, the safety device user, location of the safety device 100, heading of the safety device 100, a person involved in an emergency situation, or the like.

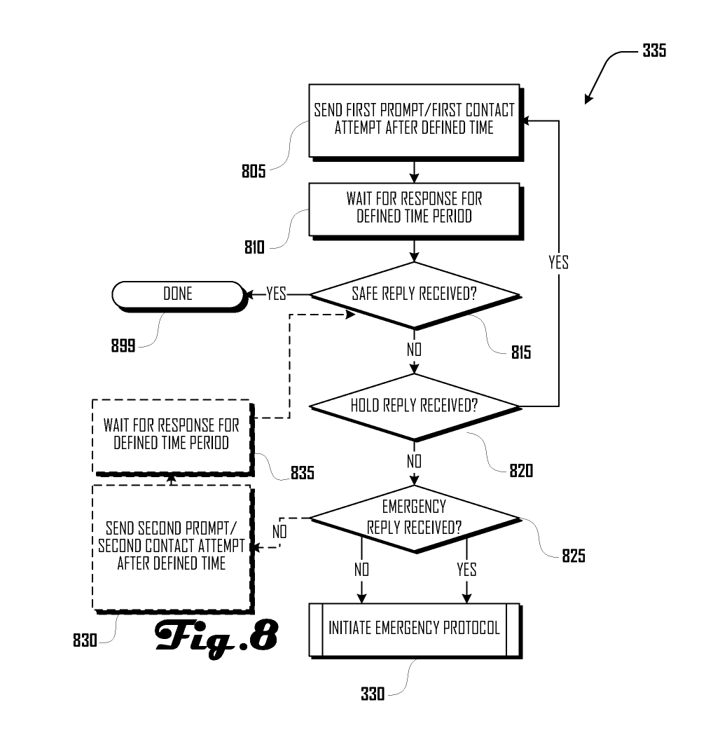

FIG. 8 is a block diagram of the non-emergency protocol 335 of FIG. 3 in accordance with an embodiment. For example, the non-emergency protocol 335 may be initiated in a situation where a safety device user believes that a dangerous situation may be imminent. The non-emergency protocol can “check in” on the safety device user and require the safety device user to respond to a prompt; otherwise, an emergency alert protocol 330 may be initiated. In some embodiments, the non-emergency protocol 335 may cause the safety device 100 to begin capturing data as discussed above (e.g., audio, video, and position data).

The method 335 begins in block 805 where a first prompt or first contact attempt is sent to the safety device 100 after a defined period of time. For example, a text message may be sent to the safety device 100 prompting the safety device user to reply to the text message within a given time. In one embodiment, the safety device user may be prompted to make a telephone call, send an e-mail, or provide an input on the safety device 100 within a defined period of time. The safety device user may be prompted to also provide a “safe word” or password in a response. In another embodiment, a telephone call may be initiated with the safety device 100.

Returning to the method 335 a defined period is allowed to pass in block 810 and in decision block 815 a determination is made whether a “safe” reply is received. If a “safe” reply is received, the method 335 is done in block 899. However, if no “safe” reply is received, a determination is made in decision block 820 whether a “hold” reply is received.

If a “hold” reply is received, the method 335 cycles back to block 805 where a first prompt or contact attempt is made. However, if a “hold” reply is not received, then a determination is made in decision block 825 whether an “emergency” reply is received. In one embodiment, an emergency protocol is initiated in method block 330 regardless of whether an “emergency” reply is received. For example, if an “emergency” reply is received, then an emergency may be present, and the emergency protocol should be initiated. However, if an “emergency” reply is not received, the safety device user has failed to respond within the defined period of time, and the safety device user may therefore be in an emergency situation and unable to respond. Therefore, the emergency protocol should be initiated.

In one embodiment, a plurality of prompts or contact attempts may be sent to the safety device 100, and subsequent prompts or contact attempts may be sent if a reply is not received or contact is not made with the safety device user within a defined time after the first contact attempt or prompt. For example, in an optional step (indicated by dashed lines) if an “emergency” reply is not received, then in block 830 a second prompt or second contact attempt is made after a defined period of time, and then in block 835 a defined period of time is allow to pass before the method 335 cycles back to decision block 815 where a determination is made whether a safe reply is received.

For example, in an embodiment, a safety device user may feel that she is potentially in danger and initiate a non-emergency protocol. The user can then be provided with a prompt, which requires the user to indicate that the user is safe and that no emergency situation has occurred or that the user still feels in danger but is not in an emergency situation, or that an emergency situation is present. If the user does not reply within the defined time period, an assumption is made that an emergency situation has occurred and that the user is unable to respond. The user can extend the non-emergency protocol by providing a “hold” reply. The user may end the non-emergency protocol by providing a “safe” reply. The user may also indicate that an emergency situation is present by providing an “emergency” reply.

In an embodiment, a call may be made to the safety device user and the user may be required to answer the call and provide an indication as to whether the user is safe, in an emergency, or whether the user still feels in danger. A plurality of calls may be initiated in some embodiments.

In an embodiment, a user may initiate a non-emergency protocol via a smart-phone application, and be prompted to provide a reply. The user may then be required to provide a response within a defined period of time via the application.

In one embodiment, where a plurality of prompts or contact attempts are made, various types of prompts or contacts attempts may be made in various orders, and may be of various types. For example, a call may be made to the safety device 100, and if no reply is received, a text message may be sent to the safety device 100. In an embodiment, contact or prompts may be sent to a device other than the safety device 100. For example, a computer, cellular telephone or smart phone that is not the safety device 100.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A method comprising:
receiving a safety device alert activation notification;
determining a user profile associated with the safety device; and
determining an alert level based on the safety device activation notification, the determination being one of a first and second alert level.

2. The method of claim 1 further comprising:
determining that a first alert level is present;
retrieving a contact list associated with the user profile;
initiating contact with at least one contact on the contact list; and
determining whether first level emergency criteria are met.

3. The method of claim 2, wherein a determination is made that first-level emergency criteria are not met, and further comprising sending an alarm-cancel message.

4. The method of claim 2, wherein a determination is made that first-level emergency criteria are met, and further comprising:
determining a first safety device location;
selecting a first set of one or more alert targets based on the first safety device location;
generating a message for at least one alert target in the first set; and
sending the alert message to the at least one alert target in the first set.

5. The method of claim 4, further comprising:
again determining that a first alert level is present;
determining a second safety device location;
determining, based on the first and second safety device location and the first set of one or more alert targets whether alert-target modification criteria are met;
determining that alert-target modification criteria are met;
selecting a second set of one or more alert targets based on the first safety device location
generating a message for at least one alert target in the second set; and
sending the alert message to the at least one alert target in the second set.

6. The method of claim 4, wherein the at least one alert target is a display screen.

7. The method of claim 4, wherein the at least one alert target is a law enforcement server.

8. The method of claim 1, further comprising:
initiating a first user contact via the safety device; and
determining whether a user-contact reply has been received.

9. The method of claim 8, further comprising:
determining that a second alert level is present; and
determining whether the user-contact reply meets one of safe-reply criteria, hold-reply criteria, and emergency-reply criteria;

10. The method of claim 9, further comprising:
determining that the user-contact reply meets safe-reply criteria; and
sending an alert-cancel message.

11. The method of claim 9, further comprising:
determining that the user-contact reply meets hold-reply criteria;
initiating a second first user contact via the safety device; and
determining whether a second user-contact reply has been received.

12. The method of claim 9, further comprising:
determining that the user-contact reply meets emergency-reply criteria; and
sending a safety device emergency activation message to the safety device.

13. The method of claim 9, further comprising:
determining that the user-contact reply meets emergency-reply criteria;
determining a first safety device location;
selecting a first set of one or more alert targets based on the first safety device location;
generating a message for at least one alert target in the first set; and
sending the alert message to the at least one alert target in the first set.

14. The method of claim 13, further comprising:
again determining that a first alert level is present;
determining a second safety device location;
determining, based on the first and second safety device location and the first set of one or more alert targets whether alert-target modification criteria are met;
determining that alert-target modification criteria are met;
selecting a second set of one or more alert targets based on the first safety device location;
generating a message for at least one alert target in the second set; and,
sending the alert message to the at least one alert target in the second set.

15. The method of claim 13, wherein the at least one alert target is a display screen.

16. The method of claim 13, wherein the at least one alert target is a law enforcement server.

17. The method of claim 8 wherein initiating a first user contact via the safety device comprises sending a text message.

18. The method of claim 8 wherein initiating a first user contact via the safety device comprises initiating a cellular telephone call.
